(19) United States
(12) Patent Application Publication
(10) Pub. No.: US 2026/0024340 A1
(43) Pub. Date: Jan. 22, 2026

(54) METHOD AND SYSTEM FOR CCTV-INTEGRATED MONITORING

(71) Applicant: Electronics and Telecommunications Research Institute, Daejeon (KR)

(72) Inventors: Hyun Jin YOON, Daejeon (KR); Geon Woo KIM, Daejeon (KR); Sang Wook PARK, Daejeon (KR); So Hee PARK, Daejeon (KR); Seon Ho OH, Daegu (KR)

(73) Assignee: Electronics and Telecommunications Research Institute, Deajeon (KR)

(21) Appl. No.: 19/055,652

(22) Filed: Feb. 18, 2025

(30) Foreign Application Priority Data
Jul. 16, 2024 (KR) 10-2024-0094017
Jan. 6, 2025 (KR) 10-2025-0001376

(51) Int. Cl. G06V 20/52; G06T 7/20; G06V 10/25; G06V 10/26; G06V 10/74; G06V 10/762; H04N 7/18

(52) U.S. Cl. CPC G06V 20/52; G06T 7/20; G06V 10/25; G06V 10/26; G06V 10/761; G06V 10/762; H04N 7/18; G06T 2207/20084; G06T 2207/30196; G06V 2201/07

(57) ABSTRACT

A method and system for cctv-integrated monitoring is disclosed.

The present disclosure relates to a system and a method for CCTV-integrated monitoring, which find and provide a current location and a movement route of a monitored subject to be monitored through a similarity comparison considering a re-identification difficulty between a human area image acquired from a real-time CCTV video after escaping, and a secured monitored subject image.

### CROSS-REFERENCE TO RELATED APPLICATION

This application claims priority to Korean Patent Application No. 10-2024-0094017, filed on Jul. 16, 2024 and No. 10-2025-0001376, filed on Jan. 6, 2025 in the Korea Intellectual Property Office, the entire contents of which are incorporated herein by reference.

### TECHNICAL FIELD

The present disclosure relates to a system and a method for CCTV-integrated monitoring. More particularly, the present disclosure relates to a system and a method for CCTV-integrated monitoring, which find and provide a current location and a movement route of a monitored subject to be monitored through a similarity comparison considering a re-identification difficulty between a human area image acquired from a real-time CCTV video after escaping, and a secured monitored subject image.

### BACKGROUND

The statements in this section merely provide background information related to the present disclosure and do not necessarily constitute prior art.

In Korea, a GPS-based electronic monitoring system is operated in order to prevent re-offering of a sex offender who is likely to be repeatedly offended. When location information of a sex offender attached with an electronic tagging is delivered to the central control center of the Ministry of Justice in real time by using a GPS transmitter, a subject is managed and supervised for 24 hours by determining whether the electronic tagging is not worn, whether a path is departed, whether to violate approach prohibition, etc.

However, when the monitored subject damages the electronic tagging or crops the electronic tagging, and then escapes, there is a problem in that a position of the monitored subject cannot be tracked any longer only with a current electronic monitoring system. In particular, since an actual physical description of the monitored subject upon escaping cannot be known only with GPS position information, it is difficult to specify or track the monitored subject.

For this reason, there is a trend in which multiple CCTV videos are utilized in order to specify or the escaped monitored subject or suspect or determine a location of the monitored subject or suspect. However, there is a problem that it takes a lot of time and personnel because a police detective generally should secure all CCTV videos within hundreds of meters based on a case occurrence location and check the secured CCTV images, and find the monitored subject.

In recent years, there has been an increase in attempts to identify their real-time or post-movement paths by re-identifying the same identity in multiple videos using a deep neural network model. A human re-identification technology is a technology that converts a human image into a multi-dimensional feature vector, and calculates a similarity between extracted feature vectors to find images having the same identity.

However, the conventional human re-identification technology is intended to extract the visual feature vector in its own identity from a full body image. Accordingly, re-identification performance in images with a complete full body is excellent. However, there is a technical limit that the performance is not inevitably reduced in a non-full body part image which is occluded by an obstacle and which departs from a camera photographing area and which is partially cropped, an image in which a physical description such as hemp, disguise, etc., is significantly changed, and an image having a remote low resolution.

### SUMMARY

In view of the above, the present disclosure provides a system for CCTV-integrated monitoring, which can secure an image containing information on a physical description of a monitored subject upon a case by integrating with a CCTV video control system when an electronic tagging is damaged, and rapidly search a current location of the monitored subject, and continuously track and monitor a movement path.

The objects to be achieved by the present disclosure invention are not limited to the aforementioned objects, and other objects, which are not mentioned above, will be apparent to a person having ordinary skill in the art from the following description.

An embodiment of the present disclosure provides a method for CCTV-integrated monitoring, the method comprising: a process of generating video object metadata by receiving videos photographed by a plurality of cameras; a process of generating a movement path re-identification query by using a camera list overlapped with a GPS movement path of a monitored subject and search time zone information integrated with the monitored subject; a process of searching video object metadata integrated with the monitored subject based on the generated movement path re-identification query; a process of deriving a plurality of persons which move along the GPS movement path, and a camera unit movement path of each person and an image of each person, based on the searched video object metadata; a process of visualizing and providing the derived movement path information and person image to an interface based on a GPS; a process of generating a monitored subject re-identification query based on a monitored subject image selected from the interface and video object metadata corresponding to the monitored subject image; a process of matching the monitored subject and integrated new video object metadata in new video object metadata generated in real time by the plurality of cameras based the monitored subject re-identification query; and a process of tracking a real-time location of the monitored subject based on a matching result for the monitored subject re-identification query.

Another embodiment of the present disclosure provides a system for CCTV-integrated monitoring, the system comprising: at least one memory; and at least one processor, wherein the at least one processor executes instructions to generate video object metadata by receiving videos photographed by a plurality of cameras, generate a movement path re-identification query by using a camera list overlapped with a GPS movement path of a monitored subject and search time zone information integrated with the monitored subject, search video object metadata integrated with the monitored subject based on the generated movement path re-identification query, derive a plurality of persons which move along the GPS movement path, and a camera unit movement path of each person and an image of each person, based on the searched video object metadata, visualize and provide the derived movement path information and person image to an interface based on a GPS, generate a monitored subject re-identification query based on a monitored subject image selected from the interface and video object metadata corresponding to the monitored subject image, match the monitored subject and integrated new video object metadata in new video object metadata generated in real time by the plurality of cameras based the monitored subject re-identification query, and track a real-time location of the monitored subject based on a matching result for the monitored subject re-identification query.

According to an embodiment of the present disclosure, there is an effect in which since a location of a monitored subject can be continuously tracked and monitored based on a CCTV video even after an electronic tagging is damaged, a search range can be minimized.

According to an embodiment of the present disclosure, there is an effect in which a re-identification matching criterion can be adjusted by considering a re-identification difficulty of an actual video image, so the monitored subject can be more accurately identified.

According to an embodiment of the present disclosure, there is an effect in which physical description information of the monitored subject upon escaping can be secured, so a crime can be prevented by rapidly specifying and arresting the monitored subject.

The advantageous effects of the present disclosure are not limited to those described above; other advantageous effects of the present disclosure not mentioned above may be understood clearly by those skilled in the art from the descriptions given below.

### BRIEF DESCRIPTION OF THE DRAWINGS

FIG. 1 is a block diagram schematically illustrating an environment to which a CCTV-integrated monitoring system may be applied according to an embodiment of the present disclosure.

FIG. 2 is a block diagram illustrating a metadata generator according to an exemplary embodiment of the present disclosure.

FIG. 3 is a block diagram illustrating a re-identification difficulty calculator according to an embodiment of the present disclosure.

FIG. 4 is a diagram exemplarily illustrating bounding boxes A, B, C, D, and E which a human detector generates with respect to an input image according to an embodiment of the present disclosure.

FIG. 5 is a diagram for describing a process of generating video object metadata by the metadata generator according to an embodiment of the present disclosure.

FIG. 6 is a block diagram illustrating a movement path re-identifier according to an embodiment of the present disclosure.

FIG. 7 is a block diagram illustrating a GUI according to an embodiment of the present disclosure.

FIG. 8 is a block diagram illustrating a monitored subject re-identifier according to an embodiment of the present disclosure.

FIG. 9 is a flowchart illustrating an operation process of the CCTV-integrated monitoring system according to an embodiment of the present disclosure.

FIG. 10 is a diagram exemplifying an identical human matching result for a video photographed by a single camera according to an embodiment of the present disclosure.

FIG. 11 is a diagram exemplifying an identical human cluster matching result between multiple cameras acquired by a second matcher according to an embodiment of the present disclosure,

FIG. 12 is a diagram exemplifying camera-specific representative images according to an embodiment of the present disclosure.

FIG. 13 is a diagram exemplifying a result image of matching an identical identity between a monitored subject re-identification query acquired by a similarity comparator considering a re-identification difficulty and a real-time video object according to an embodiment of the present disclosure.

FIG. 14 is a diagram exemplifying a monitored subject image and camera-specific matching images according to an embodiment of the present disclosure.

FIG. 15 is a block configuration diagram schematically illustrating an exemplary computing device which may be used for implementing a method and a device according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

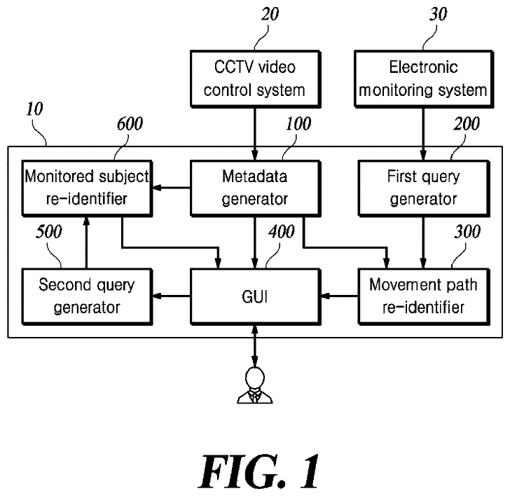

FIG. 1 is a block diagram schematically illustrating an environment to which a CCTV-integrated monitoring system 10 may be applied according to an embodiment of the present disclosure.

The CCTV-integrated monitoring system 10 according to an embodiment of the present disclosure may include all or some of a metadata generator 100, a first query generator 200, a movement path re-identifier 300, a graphical user interface (GUI) 400, a second query generator 500, and a monitored subject re-identifier 600. Components illustrated in FIG. 1 represent elements which are functionally distinguished, and may also be implemented as a form in which one or more components are integrated with each other in an actual physical environment.

The metadata generator 100 may receive a plurality of CCTV camera videos from an external CCTV video control system 20. The CCTV video control system 20 may include a plurality of CCTV cameras. The metadata generator 100 generates video object metadata by the received camera image.

The first query generator 200 receives a latest GPS movement path of the monitored subject when an abnormal situation such as damage, breakage, failure, etc., of a monitoring device from an electronic monitoring system 30 based on a location tracking device. The electronic monitoring system 30 may include a plurality of electronic location tracking devices or electronic devices (e.g., a mobile device, a sensor, a communication device, etc.) for monitoring a location or a state of the monitored subject. Here, the latest GPS movement path of the monitored subject may be a sequence type GPS movement path in which coordinates for a latitude and a longitude for a predetermined time just before the abnormal situation of the monitored subject occurs are consecutively listed. The first query generator 200 may generate a movement path re-identification query by using a CCTV camera list overlapped with the GPS movement path of the monitored subject and search time zone information integrated with the monitored subject. Here, the search time zone information may mean a time when the movement path of the monitored subject is terminated from a time when the movement path of the monitored subject is started. The re-identification query is a data structure generated to check or track an identity of a specific object. The movement path re-identification query means a query for tracking the movement path and checking the same identity based on a camera list overlapped with the movement path of the monitored subject and timestamp.

The movement path re-identifier 300 receives the video object metadata from the metadata generator 100 in real time. Here, the video object metadata is data corresponding to the camera list of the movement path re-identification query and a search time zone condition. That is, the movement path re-identifier 300 may derive a plurality of humans which move along the GPS movement path, and a camera unit movement path of each human and an image of each human, based on the searched video object metadata.

The GUI 400 may visualize a movement path re-identification query processing result, and provide the visualized movement path re-identification query processing result to a supervisor, and provide an interface which enables the supervisor to select an image in which physical description information of a double monitored subject is definitely captured.

The second query generator 500 may generate the re-identification query of the monitored subject based on the image of the monitored subject selected by the supervisor and video object metadata corresponding to the image of the monitored subject.

The monitored subject re-identifier 600 may determine whether the monitored subject is an object having the same identity as the monitored subject by determining a similarity between the real-time video object metadata generated by the metadata generator 100 and the video object metadata of the re-identification query of the monitored subject generated by the second query generator 500. The monitored subject re-identifier 600 may continuously track a real-time location of the monitored subject based on the matching result for the re-identification query of the monitored subject.

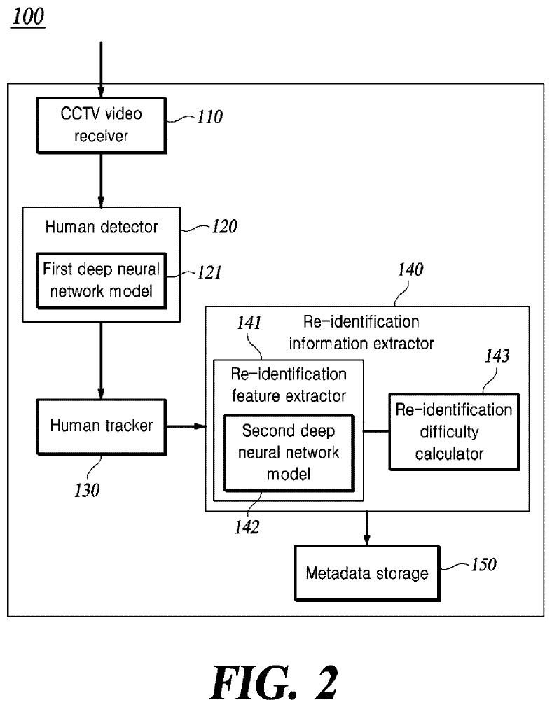

FIG. 2 is a block diagram illustrating a metadata generator 100 according to an embodiment of the present disclosure.

The metadata generator 100 according to an embodiment of the present disclosure may include all or some of a CCTV video receiver 110, a human detector 120, a human tracker 130, a re-identification information extractor 140, and a metadata storage 150.

The CCTV video receiver 110 receives a plurality of CCTV camera videos from a video distribution server of the CCTV video control system 20.

The human detector 120 may detect one or more human objects from the camera video received from the CCTV video receiver 110 by using a pretrained first deep neural network model 121, and generate bounding box information of each object.

The human tracker 130 may track a location of a human object detected from a single camera video, and allocate an individual unique number to each object.

The re-identification information extractor 140 may include all or some of a re-identification feature extractor 141 and a re-identification difficulty calculator 143. The re-identification information extractor 140 may extract information to be used for re-identify the monitored subject by using a human area image cropped based on the bounding box of the human object as an input.

The re-identification feature extractor 141 applies the human area image cropped based on the bounding box of the human object to a pretrained second deep neural network model 142, and convert the human area image into a multi-dimensional re-identification feature vector. The second deep neural network model 142 may use a deep neural network model trained so as to decrease a metric between re-identification feature vectors extracted from the human area images having the same identity, and increases a metric between feature vectors extracted from images having different identities. The second deep neural network model 142 may extract a feature vector to identify an identity even with respect to a human area image in which the physical description is changed as the monitored subject changes clothes or is disguised after escaping. The second deep neural network model 142 may be constituted by a plurality of models. The second neural network model 142 may be trained to extract a re-identification feature vector which is resistant to change of clothes or disguise. To this end, human attribute information (e.g., gender, age, body type, height, and head shape) which is commonly maintained in a human area image in which clothes of the same identity are changed during model training may be utilized for defining a loss function required for model training jointly with identity information.

The re-identification difficulty calculator 143 receives coordinates of the bounding box and the human area image as an input to quantify the re-identification difficulty of the human area image.

The metadata storage 150 may store the video object metadata including a unique number of a camera photographing each video, a timestamp in which the video is photographed, a unique number of the tracked object, bounding box information, a human re-identification feature vector extracted with respect to a tracked individual object, a re-identification difficulty, and a human area image.

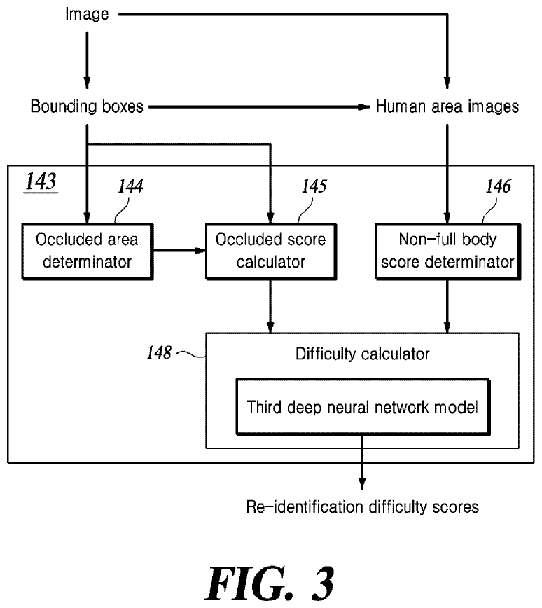

FIG. 3 is a block diagram illustrating a re-identification difficulty calculator 143 according to an embodiment of the present disclosure. In order to describe FIG. 3, FIG. 2 may be referred jointly.

The re-identification difficulty calculator 143 according to an embodiment of the present disclosure may include all or some of an occluded area determinator 144, an occluded score calculator 145, a non-full body score calculator 146, and a difficulty calculator 148.

The occluded area determinator 144 determines whether a human object in a video is occluded by another human object in the human area image by using coordinate information of the bounding box of the object acquired by the human detector 120. The occluded area determinator 144 may calculate an overlapping area of a bounding box area of the other person overlapped with the human area image. When a value of a bottom y coordinate of the bounding box of the other person is smaller than a bottom y coordinate of the human area image, the occluded area determinator 144 may determine a situation in which the other person is positioned on a rear surface of a human corresponding to the human area image, and does not actually occlude the corresponding human, and exclude the other person from determination of an occluded area.

The occluded score calculator 145 calculates an occlusion score as a ratio of the occluded area in the human area image. That is, the occluded score calculator 145 may calculate a ratio occupied by an overlapping area with a bounding box of a human object.

The non-full body score calculator 146 classifies whether the human area image is a full body image or whether the human area image is a partial image of a cropped non-full body which is occluded by an obstacle or which departs from a camera photographing range. The non-full body calculator 146 may use a non-full classification prediction value of a model for a human area image input as a non-full body score by using a third deep neural network model which classifies an input image into a full body or a non-full body. That is, the non-full body score calculator 146 may calculate a score for a non-full body degree of the human area image by using the third deep neural network model. Here, the third deep neural network model may be a model designed for image classification.

The difficulty calculator 148 may use an average of an occluded score and a non-full body score as a final re-identification difficulty score. Further, since a re-identification performance may be deteriorated when a size of the human area image is too small or a quality is too low, the difficulty calculator 148 may additionally an image size and quality information for calculating the re-identification difficulty.

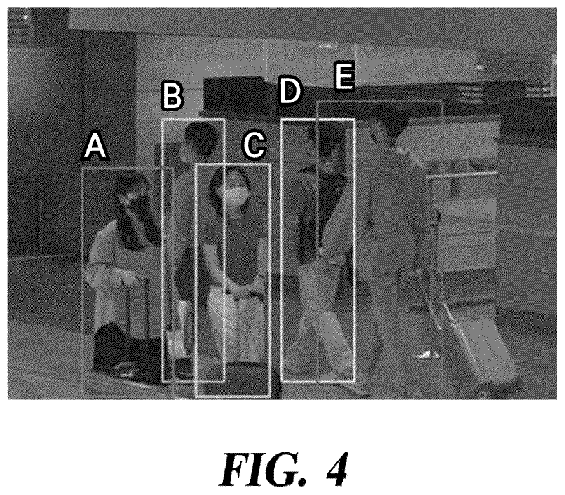

FIG. 4 is a diagram exemplarily illustrating bounding boxes A, B, C, D, and E which a human detector 120 generates with respect to an input image according to an embodiment of the present disclosure.

Table 1 exemplifies a re-identification difficulty calculation result which the re-identification difficulty calculator 143 generates with respect the generated bounding boxes.

TABLE 1

| | A | B | C | D | E |
|---|---|---|---|---|---|
| (i) Occluded area | ∅ | B ∩ A, B ∩ C | ∅ | D ∩ E | ∅ |
| (ii) Occluded score | $\frac{∅}{A} = 0$ | $\frac{B ⋂ A + N ⋂ C}{B} = 0.48$ | $\frac{∅}{c} = 0$ | $\frac{D ⋂ E}{D} = 0.5$ | $\frac{∅}{E} = 0$ |
| iii) Non-full | 0.72 | 0.78 | 0.68 | 0.48 | 0.01 |
| body score | | | | | |
| (iv) Re-identification | 0.36 | 0.63 | 0.34 | 0.5 | 0.005 |
| difficulty | | | | | |

Referring to FIG. 4 and Table 1, a first bounding box A and a second bounding box B are overlapped with each other. Since a bottom y-axis coordinate of the first bounding box A is larger than a bottom y-axis coordinate of the second bounding box B, an occluded score of the first bounding box A may be determined as 0. In the case of a person within the first bounding box A, since a lower body is in a state of being occluded by a carrier, a non-full body score may be calculated as a high value of 0.72. Finally, the re-identification difficulty may become 0.36 which is an average of 0 and 0.72.

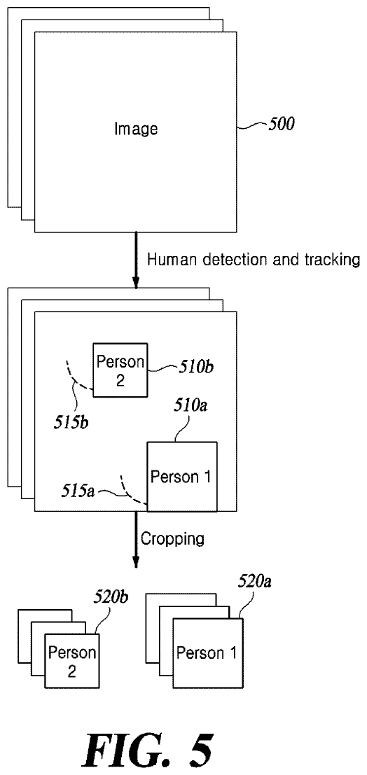

FIG. 5 is a diagram for describing a process of generating video object metadata by the metadata generator 100 according to an embodiment of the present disclosure. In order to describe FIG. 5, FIG. 2 may be referred jointly.

Referring to FIG. 5, the metadata generator 100 detects a human object within each received image 500. The detected human object is represented as bounding boxes 510a and 510b. The metadata generator 100 tracks the detected human object throughout multiple frames to identify continuous movement paths 515a and 515b of individual objects. The metadata generator 100 crops an image 500 based on a human object bounding box area, and normalizes a color, a size, etc., if necessary to generate a human area image 520.

The metadata generator 100 may store a unique number of a camera photographing the image 500, a timestamp in which the image 500 is photographed, unique numbers assigned to individual tracked objects, information on the bounding box 510, human re-identification feature vectors extracted with respect to the individual tracked objects, a re-identification difficulty calculated with respect to the human area image 520, and the human area image 520 in the video object metadata storage 150 as the video object metadata.

Table 2 exemplarily illustrates video object metadata generated from a plurality of camera videos. Information not required for a description in Table 2 is omitted as “-”.

TABLE 2

| Unique | Unique | | | | Re- | Human |
|---|---|---|---|---|---|---|
| number of | number of | | | | identification | area |
| camera | tracked object | Time stamp | Bounding box | Human re-identification feature vector | difficulty | image |
| C001 | T11 | 20231127131516.333 | [450, 10, 33, 90] | [0.61345, 3.02708, 1.53112, . . . , −1.8660] | 0.08 | — |
| C001 | T12 | 20231127131516.333 | [633, 680, 101, 220] | [0.77540, −0.40084, 1.945075, . . . , −0.60371] | 0.98 | — |
| C002 | T13 | 20231127131516.333 | [633, 240, 102, 255] | [0.81558, 1.020225, −0.79078, −0.83054] | 0.02 | — |
| . . . | . . . | . . . | . . . | . . . | . . . | . . . |

For example, referring to FIG. 5 and Table 2, a unique number T11 may be assigned to person 1 and a unique number T12 may be assigned to person 2. At this time, the timestamp, the bounding box, the feature vector, and the difficulty stored as the video object metadata may be information extracted from any one of multiple frames. For example, information in a frame in which the human is last detected or a frame having a lowest re-identification difficulty may be stored in the metadata storage 150.

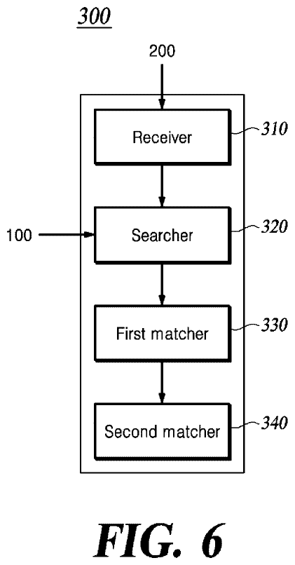

FIG. 6 is a block diagram illustrating a movement path re-identifier 300 according to an embodiment of the present disclosure. In order to describe FIG. 6, FIG. 1 may be referred jointly.

The movement path re-identifier 300 according to an embodiment of the present disclosure may include all or some of a receiver 310, a searcher 320, a first matcher 330, and a second matcher 340.

The receiver 310 receives a movement path re-identification query from the re-identification query generator 200.

The searcher 320 sets a camera list and a search time zone included in the movement path re-identification query as a search condition to search video object metadata which satisfies the search condition from the metadata storage 150. The searched video object metadata is hereinafter used for an identical person matching process.

The first matcher 330 performs clustering for each single camera with respect to a re-identification feature vector of the searched video object metadata to acquire an identical person cluster. The first matcher 330 may also determine whether the human is the identical person by using a tracking object unique number of the video object metadata. However, since a plurality of tracking errors may occur in the tracking step of the human tracker 130, it may be determined whether the human is the identical person by performing clustering based identical person matching. Here, the plurality of tracking errors may include an error in which a plurality of tracking object unique numbers are assigned to the identical person or an error in which the same tracking object unique number is assigned to a plurality of identities, but are not limited thereto. When the first matcher 330 determines the identical person within a single camera, the first matcher 330 may minimize an influence of an outlier due to an external change such as an occluded or post change. Further, since the first matcher 330 may not know the number of humans which move actually in a queried camera video, the first matcher 330 may utilize an HDBSCAN clustering algorithm in which parameter setting of controlling a cluster count is comparatively easy. The first matcher 330 may use a cosine similarity function or a Euclidean distance as a similarity between re-identification feature vectors for clustering.

The second matcher 340 determines an identical cluster pair in which a plurality of different cameras are similar within a queried camera list by using a linear assignment algorithm. Thereafter, the second matcher 340 may re-identify an identical person cluster according to an entire camera list order, and derive a plurality of humans which move along a queried movement path and individual movement paths recorded in respective cameras. The second matcher 340 may use the cosine similarity function or the Euclidean distance as the similarity between re-identification feature vectors for clustering.

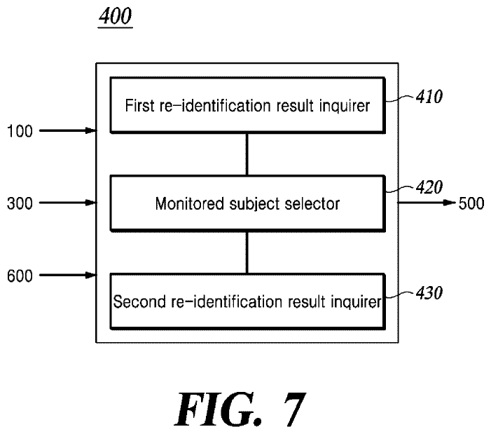

FIG. 7 is a block diagram illustrating a GUI 400 according to an embodiment of the present disclosure.

The GUI 400 according to an embodiment of the present disclosure may include all or some of a first re-identification result inquirer 410, a monitored subject selector 420, and a second re-identification result inquirer 430.

The GUI 400 may provide a movement path re-identification result acquired by the movement path re-identifier 300 to the supervisor by using the first re-identification result inquirer 410.

The first re-identification result inquirer 410 may additionally provide a map interface which may intuitively check whether a GPS movement path of the monitored subject and a movement path of the camera coincide with each other. Here, the map interface is a map visualized by overlapping the GPS movement path of the monitored subject and the camera-unit movement path.

The monitored subject selector 420 may provide a plurality of images including a physical description of the monitored subject to the supervisor in the movement path re-identification result.

The second re-identification result inquirer 430 may provide a monitored subject re-identification query result to the supervisor. The second re-identification result inquirer 430 may additionally provide the map interface. Here, the map interface is a map which jointly visualizes camera location information and an image of a matched video object.

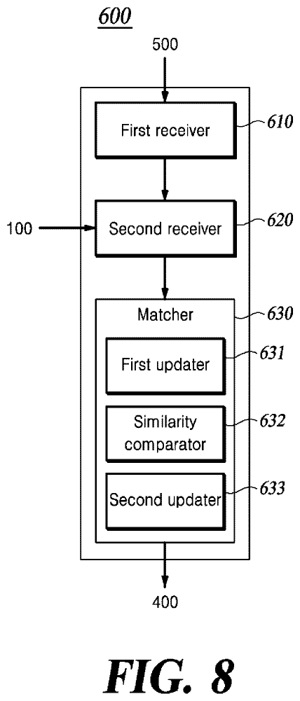

FIG. 8 is a block diagram illustrating a monitored subject re-identifier 600 according to an embodiment of the present disclosure.

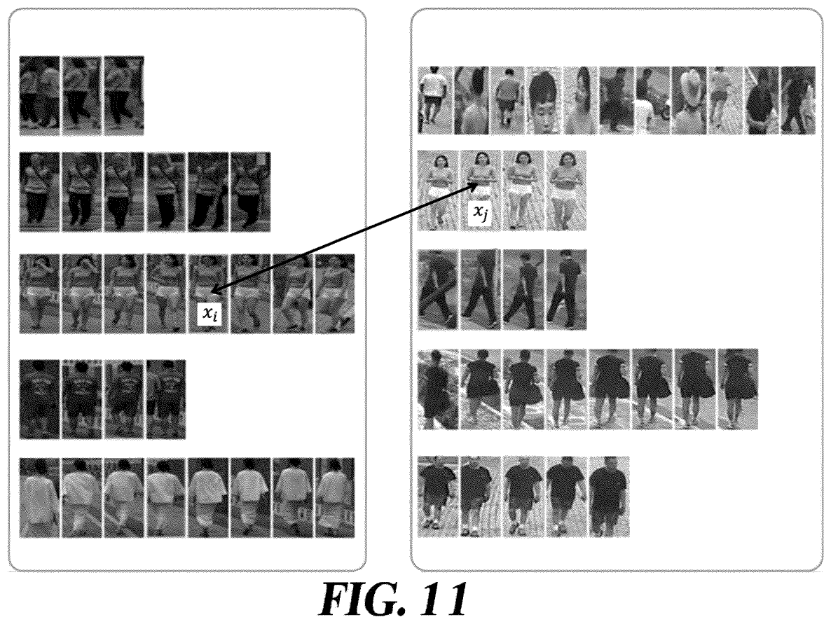

The monitored subject re-identifier 600 according to an embodiment of the present disclosure may include all or some of a first receiver 610, a second receiver 620, and a matcher 630. In order to describe FIG. 11, FIG. 1 may be referred jointly.

The first receiver 610 receives a monitored subject re-identification query generated by the second query generator 500. Here, the monitored subject re-identification query may include at least one of a monitored subject image, video object metadata of the monitored subject image, and a camera list to find the monitored subject.

The second receiver 620 receives video object data which the metadata generator 100 generates from a real-time CCTV video. Here, the video object metadata may include a stream of the video object metadata.

The matcher 630 may include all or some of a first updater 631, a similarity comparator 632, and a second updater 633.

The matcher 630 performs a similar comparison by considering a re-identification difficulty between new video object metadata integrated with the monitored subject and the monitored subject re-identification query generated by the second query generator 500 from the second receiver 620. Thereafter, the matcher 630 may determine a real-time video object of the same identity, and output location information of the matched video object.

The first updater 631 analyzes new video object metadata integrated with the monitored subject to identify a video object which is likely to compare the monitored subject re-identification query, and generates or updates a video object image based on the identified object to increase efficiency of a re-identification task.

The similarity comparator 632 may calculate a similarity between a re-identification feature vector of the new video object metadata and a re-identification feature vector of the monitored subject re-identification query. Here, the similarity comparator 632 may use the cosine similarity or the Euclidean distance in calculating the similarity. Thereafter, a predetermined matching threshold may be dynamically adjusted in proportion to a larger value between a re-identification difficulty score of the monitored subject re-identification query a re-identification difficulty of the new video object metadata. That is, the matching threshold may be adjusted to increase or decrease. The similarity comparator 632 may adjust a matching criterion, and then finally determine a video object matched with the re-identification query. That is, the similarity comparator 632 compares a similarity and adjusted matching threshold to determine whether the monitored subject and a person corresponding to the new video object metadata are objects having the same identity.

The second updater 633 may add the re-identification feature vector and the re-identification difficulty of the finally matched new video object metadata to the monitored subject re-identification query, and utilize the added monitored subject re-identification query for comparing the similarity afterwards.

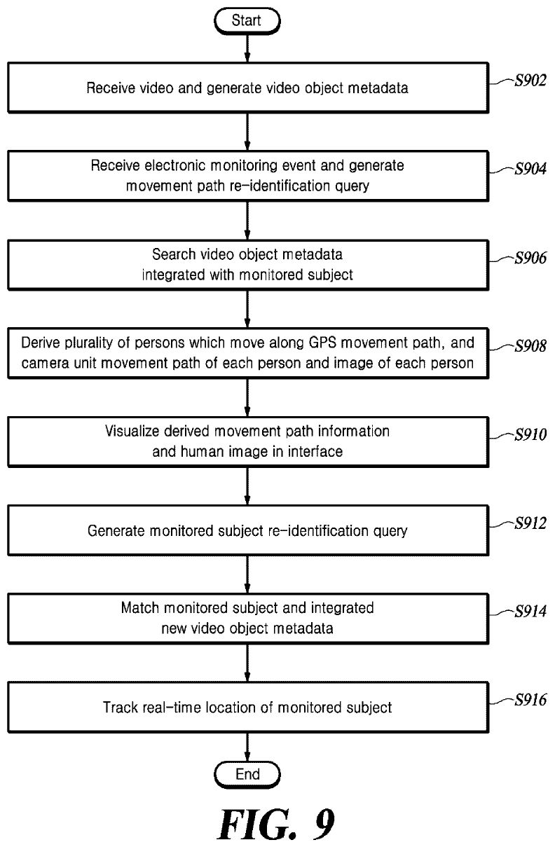

FIG. 9 is a flowchart illustrating an operation process of the CCTV-integrated monitoring system 10 according to an embodiment of the present disclosure.

The CCTV-integrated monitoring system 10 receives videos photographed by a plurality of cameras from the CCTV video control system 20, and generates video object metadata (S902). The CCTV-integrated monitoring system 10 detects one or more human objects from the received videos by using a pretrained first deep neural network model 121, and generates bounding box information of each object. Thereafter, the CCTV-integrated monitoring system 10 tracks a location of the detected human object, and assigns an individual unique number to each object. The CCTV-integrated monitoring system 10 applies a human area image cropped based a bounding box of a human object to a pretrained second deep neural network model 142, and converts the human area image into a multi-dimensional re-identification feature vector. The CCTV-integrated monitoring system 10 receives coordinates of the bounding box and the human area image as an input to quantify a re-identification difficulty of the human area image. Here, the video object metadata may include a unique number of a camera photographing each video, a timestamp in which the video is photographed, a unique number of the tracked individual object, bounding box information, a human re-identification feature vector extracted with respect to the tracked individual object, a re-identification difficulty, and the human area image.

The CCTV-integrated monitoring system 10 generates a movement path re-identification query by using a CCTV camera list overlapped with the GP movement path of the monitored subject and search time zone information integrated with the monitored subject (S904).

The CCTV-integrated monitoring system 10 may search video object metadata integrated with the monitored subject based on the generated movement path re-identification query (S906).

The CCTV-integrated monitoring system 10 may derive a plurality of persons which move along the GPS movement path, and a camera unit movement path of each person and an image of each person, based on the searched video object metadata (S908).

The CCTV-integrated monitoring system 10 may visualize the derived movement path information and human image to an interface based on a GPS, and provide the visualized movement path information and human image to the supervisor (S910).

The CCTV-integrated monitoring system 10 generates a monitored subject re-identification query based on a monitored subject image selected by the supervisor and video object metadata corresponding to the monitored subject image (S912). Here, the monitored subject re-identification query may include at least one of the monitored subject image, the video object metadata of the monitored subject image, and a camera list to find the monitored subject.

The CCTV-integrated monitoring system 10 may match a monitored subject and new integrated video object metadata in new video object metadata generated in real time by the plurality of cameras based on the monitored subject re-identification query (S914).

The CCTV-integrated monitoring system 10 tracks a real-time location of the monitored subject based on a matching result for the monitored subject re-identification query (S916).

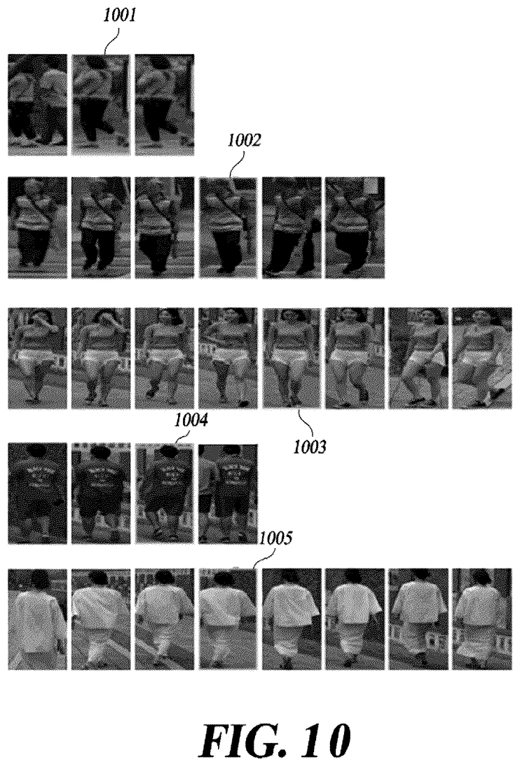

Hereinafter, referring to FIGS. 10 to 14 and Tables 3 to 6, a result in which the CCTV-integrated monitoring system 10 according to an embodiment of the present disclosure is applied to an actual video will be described.

FIG. 10 is a diagram exemplifying an identical person matching result for a video photographed by a single camera according to an embodiment of the present disclosure. In order to describe FIG. 10, FIG. 6 may be referred jointly.

Referring to Table 3 jointly, the searcher 320 acquires 89 video object metadata from camera #1 with respect to a movement path re-identification query constituted by a specific camera list (e.g., 1, 11, 12, 30, 29, 14, and 23). The searcher 320 analyzes re-identification feature vectors included in 89 received video object metadata, and clusters objects having a similar feature and acquires 12 identical person clusters. FIG. 10 exemplifies some clusters among 12 identical clusters acquired by camera #1. The first matcher may choose metadata of video objects 1001, 1002, 1003, 1004, and 1005 closest to a re-identification feature vector average value of the acquired identical person cluster as video object metadata representing the corresponding identical person cluster.

TABLE 3
Path Re-ID query cam_order: [1, 11, 12, 30, 29, 14, 23]
camid= 1, obj_meta_cnt= 89 → cluster_cnt= 12, outlier_cnt= 3
camid= 11, obj_meta_cnt= 571 → cluster_cnt= 84, outlier_cnt= 36
camid= 12, obj_meta_cnt= 1005 → cluster_cnt= 104, outlier_cnt= 50
camid= 30, obj_meta_cnt= 938 → cluster_cnt= 94, outlier_cnt= 51
camid= 29, obj_meta_cnt= 190 → cluster_cnt= 30, outlier_cnt= 21
camid= 14, obj_meta_cnt= 936 → cluster_cnt= 71, outlier_cnt= 48
camid= 23, obj_meta_cnt= 422 → cluster_cnt= 54, outlier_cnt= 43

FIG. 11 is a diagram exemplifying an identical person cluster matching result between multiple cameras acquired by a second matcher 340 according to an embodiment of the present disclosure. In order to describe FIG. 11, FIG. 6 may be referred jointly.

A left part of FIG. 11 represents some identical person clusters acquired by camera #1, and a right part of FIG. 11 represents some identical person cluster acquired by camera #11. A first row of FIG. 11 means a video object classified as an outlier. The second matcher 340 may determine an identical person cluster pair which is similar between cameras by using a linear assignment algorithm by receiving identical person cluster information acquired by the first matcher 330. In this process, the second matcher 340 calculates a distance between clusters by using a cosine similarity function or a Euclidean distance between representative video object metadata of the identical person cluster. When the calculated distance is smaller than a predetermined threshold (d(xᵢ, xⱼ)<θ), it may be determined that the clusters are the identical cluster pair, and new cluster representative video object metadata may be determined by integrating both matched identical person cluster information.

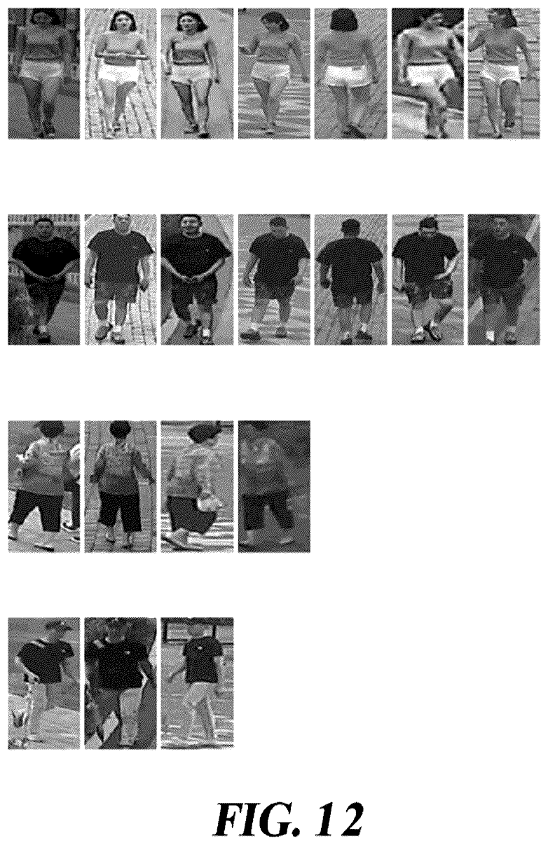

FIG. 12 is a diagram exemplifying camera-specific representative images according to an embodiment of the present disclosure. In order to describe FIG. 12, FIG. 6 may be referred jointly.

Table 4 exemplifies a movement path re-identification query generated by the first query generator 200, and a processing result of the movement path re-identifier 300 for the generated movement path re-identification query.

TABLE 4
Path Re-ID query cam_order: [1, 11, 12, 30, 29, 14, 23]
Path Re-ID output:

| Cam order | C1 | C11 | C12 | C30 | C29 | C14 | C23 | Total |
|---|---|---|---|---|---|---|---|---|
| Obj_meta_cnt | 89 | 571 | 1005 | 938 | 190 | 936 | 422 | 4151 |
| Cluster_cnt | 12 | 84 | 104 | 94 | 30 | 71 | 54 | 449 |

| | |
|---|---|
| Cam_path_cnt | 24 |

Cam_path_length (in number of cameras): 3~7, average 4.8

Referring to Table 4 jointly, the movement path re-identifier 300 may track information on movement paths of a total of 24 persons with respect to a movement path re-identification query constituted by a specific camera list (e.g., 1, 11, 12, 30, 29, 14, and 23), and provide a representative image photographed by each camera. FIG. 12 is a diagram exemplifying camera-specific representative images acquired with respect to 4 persons among 24 persons. Referring to third and fourth rows of FIG. 12, the movement path re-identifier 300 may also track a movement path of a human detected only by some of seven cameras included in the query.

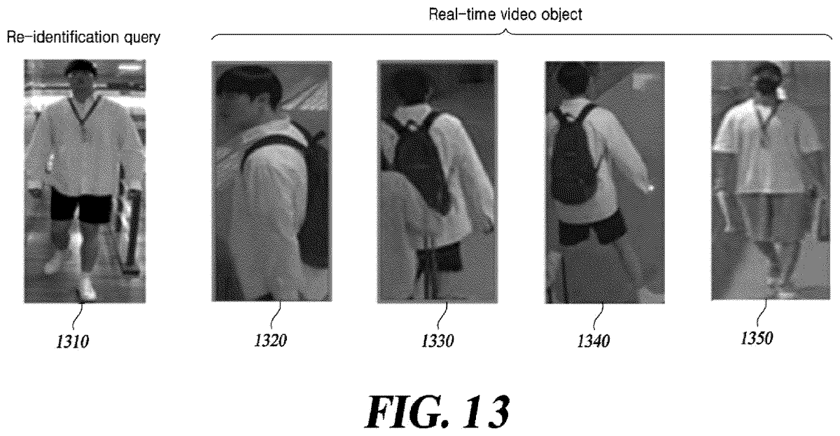

FIG. 13 is a diagram exemplifying a result image of matching an identical identity between a monitored subject re-identification query acquired by a similarity comparator 632 considering a re-identification difficulty and a real-time video object according to an embodiment of the present disclosure. In order to describe FIG. 13, FIG. 8 may be referred jointly.

Table 5 exemplifies a similarity comparison result considering a re-identification difficulty.

TABLE 5

| | | | | | |
|---|---|---|---|---|---|
| (i) Re-identification | 0.001 | 0.84 | 0.65 | 0.01 | 0.001 |
| difficulty score | | | | | |
| (ii) Similarity | | 0.3755 | 0.3459 | 0.2326 | 0.3025 |
| calculation result | | | | | |
| (cosine distance) | | | | | |
| (iii) Increase/decrease | | 0.3 + | 0.3 + | 0.3 − | 0.3 − |
| of threshold | | 0.1 = 0.4 | 0.05 = 0.35 | 0.05 = 0.25 | 0.05 = 0.25 |
| (iv) Matching | | ◯ | ◯ | ◯ | X |
| determination result | | | | | |
| Matching | | X | X | ◯ | ◯ |
| determination result | | | | | |
| (related art) | | | | | |

Referring to FIG. 13 and Table 5, a result of matching a monitored subject re-identification query 1310 and the same identity between real-time video objects 1320, 1330, 1340, and 1350 is exemplified.

A re-identification difficulty score of a first real-time video object 1320 is 0.84. A similarity calculation result of the monitored subject re-identification query 1310 and the first real-time video object 1320 is 0.3755. A value in which a predetermined threshold is adjusted with respect to the first real-time video object 1320 is 0.4. Accordingly, according to a result of matching the monitored subject re-identification query 1310 and the first real-time video object 1320, the monitored subject and the first real-time video object are determined as the same identity.

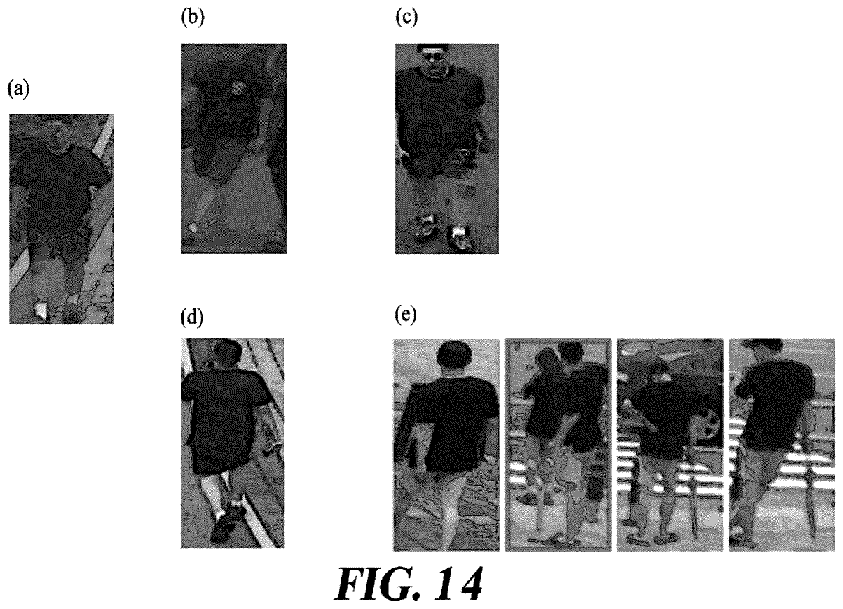

FIG. 14 is a diagram exemplifying a monitored subject image and camera-specific matching images according to an embodiment of the present disclosure. In order to describe FIG. 14, FIG. 8 may be referred jointly.

Table 6 exemplifies a monitored subject re-identification query generated by the second query generator 500 and a processing result of the monitored subject re-identifier 600 for the generated monitored subject re-identification query.

TABLE 6
Person Re-ID query info
camid=23, tid=7 (7), target_camids= [0, 2, 3, 4, 5, 6, 7, 8, 9, 10, 13, 15, 16, 17, 18, 19, 20, 21,
22, 24, 25, 26, 27, 28, 31, 32, 33, 34, 35, 36, 37, 38]
Person Re-ID output:
{‘camid’: 13, ‘tid’: 253, ‘ts’: [20180824100504767], ‘dist’: [0.013945884020929], ‘rank’: 0,
‘match_cnt’:[8], ‘batch_cnt’:[8]} #3: matching at camid=13 with tid=253, rank=0, ts=2018-
08-24 10:05:04.767000 match_cnt=[8], batch_cnt=[8]
{‘camid’: 20, ‘tid’: 17, ‘ts’: [20180824100511967], ‘dist’: [0.011790445785616721], ‘rank’:
0, ‘match_cnt’:[7], ‘batch_cnt’:[7]} #3: matching at camid=20 with tid=17, rank=0, ts=2018-
08-24 10:05:11.967000 match_cnt=[7], batch_cnt=[7]
{‘camid’: 22, ‘tid’: 47, ‘ts’: [20180824142832300], ‘dist’: [0.02036823826992995], ‘rank’: 0,
‘match_cnt’:[9], ‘batch_cnt’:[10]} #3: matching at camid=22 with tid=47, rank=0, ts=2018-
08-24 14:28:32.300000 match_cnt=[9], batch_cnt=[10]
{‘camid’: 28, ‘tid’: 429, ‘ts’: [20180824111824367, 20180824111825833,
20180824111826267, 20180824111827867], ‘dist’: [0.01576457490141636, 0.0342], ‘rank’:
0, ‘match_cnt’:[ ], ‘batch_cnt’:[ ]} #11: matching at camid=28 with tid=429, rank=0, ts=2018-
08-24 11:18:27.867000 match_cnt=[5, 0, 2, 12], batch_cnt=[5, 1, 3, 15]

Referring to Table 6 jointly, the monitored subject re-identifier 600 receives a monitored subject re-identification query constituted by a monitored subject image acquired by camera #23 video and video object metadata of the corresponding image, and a search target camera list 0, 2, 3, 4, 5, 6, . . . , 36, 37, and 38. Thereafter, a video object matched by comparing video object metadata received in a real-time video of a search target camera and a re-identification difficulty may be provided as a result jointly with camera information. (a) FIG. 14 shows a monitored subject image (i.e., a monitored subject image acquired in a camera #23 image) included in the monitored subject re-identification query, and (b) to (e) of FIG. 14 show video objects matched with camera #13, camera #20, camera #22, and camera #28, respectively. Similarity calculation results between the monitored subject image (a) and the matched video object images (b) to (e) are described below. The similarity calculation result of the monitored subject image (a) and the video object image (b) is 0.01395. The similarity calculation result of the monitored subject image (a) and the video object image (c) is 0.01179. The similarity calculation result of the monitored subject image (a) and the video object image (d) is 0.02037. The similarity calculation result of the monitored subject image (a) and the bounding-boxed video object image (e) is 0.03420.

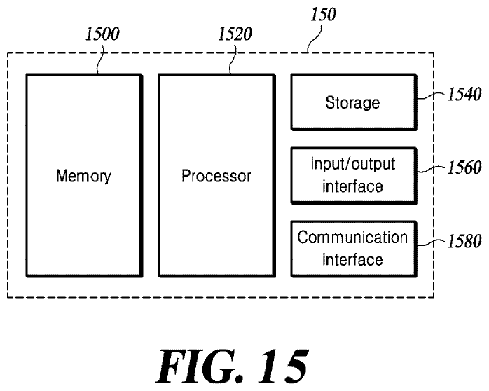

FIG. 15 is a block configuration diagram schematically illustrating an exemplary computing device which may be used for implementing a method and a device according to the present disclosure.

The computing device 150 may include all or part of a memory 1500, a processor 1520, a storage 1540, an input/output interface 1560, and a communication interface 1580. The computing device 150 may be a stationary computing device, such as a desktop computer or a server, or a mobile computing device, such as a laptop computer or a smart phone. The computing device 150 may include a specialized hardware accelerator capable of processing operations of an artificial intelligence model in an efficient manner. For example, the computing device 150 may include a graphic processing unit (GPU), a tensor processing unit (TPU), or a neural processing unit (NPU).

The memory 1500 may store a program that enables the processor 1520 to perform methods or operations according to various embodiments of the present disclosure. For example, a program may include a plurality of instructions executable by the processor 1520, and the methods or operations described above may be performed by executing the plurality of instructions by the processor 1520. The memory 1500 may consist of a single memory or a plurality of memories. In this case, information required to perform the methods or operation according to various embodiments of the present disclosure may be stored in a single memory or distributed across a plurality of memories. When the memory 1500 is composed of a plurality of memories, the plurality of memories may be physically separated. The memory 1500 may include at least one of volatile memory and non-volatile memory. Volatile memory includes Static Random Access Memory (SRAM) or Dynamic Random Access Memory (DRAM), while non-volatile memory includes flash memory.

The processor 1520 may include at least one core capable of executing at least one instruction. The processor 1520 may execute instructions stored in the memory 1500. The processor 1520 may consist of a single processor or a plurality of processors.

The storage 1540 maintains stored data even if power supplied to the computing device 150 is cut off. For example, the storage 1540 may include non-volatile memory or may include a storage medium such as a magnetic tape, an optical disk, or a magnetic disk. A program stored in the storage 1540 may be loaded into the memory 1500 before being executed by the processor 1520. The storage 1540 may store files written in a program language, and a program created from the files by a compiler may be loaded into the memory 1500. The storage 1540 may store data to be processed by the processor 1520 and/or data processed by the processor 1520.

The input/output interface 1560 may provide an interface with an input device such as a keyboard or a mouse and/or an output device such as a display device or a printer. The user may trigger execution of a program by the processor 1520 through the input device and/or check the processing results of the processor 1520 through the output device.

The communication interface 1580 may provide access to an external network. The computing device 150 may communicate with other devices through the communication interface 1580.

Each component of the device or method according to the present disclosure may be implemented in hardware, software, or a combination of hardware and software. Additionally, the functions of each component may be implemented in software, and a microprocessor may be configured to execute the functions of the software corresponding to each component.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A method for CCTV-integrated monitoring, the method comprising:
a process of generating video object metadata by receiving videos photographed by a plurality of cameras;
a process of generating a movement path re-identification query by using a camera list overlapped with a GPS movement path of a monitored subject and search time zone information integrated with the monitored subject;
a process of searching video object metadata integrated with the monitored subject based on the generated movement path re-identification query;
a process of deriving a plurality of persons which move along the GPS movement path, and a camera unit movement path of each person and an image of each person, based on the searched video object metadata;
a process of visualizing and providing the derived movement path information and person image to an interface based on a GPS;
a process of generating a monitored subject re-identification query based on a monitored subject image selected from the interface and video object metadata corresponding to the monitored subject image;
a process of matching the monitored subject and integrated new video object metadata in new video object metadata generated in real time by the plurality of cameras based the monitored subject re-identification query; and
a process of tracking a real-time location of the monitored subject based on a matching result for the monitored subject re-identification query.

2. The method of claim 1, wherein the process of generating the video object metadata includes
a process of detecting one or more human objects from the received videos by using a pretrained first deep neural network model, and generating bounding box information of each object,
a process of tracking a location of the detected human object, and assigning an individual unique number to each object;
a process of applying a human area image cropped based on the bounding box of the human object to a pretrained second deep neural network model, and converting the human area image to a multi-dimensional re-identification feature vector, and
a process of quantifying a re-identification difficulty of the human area image by using coordinates of the bounding box and the human area image.

3. The method of claim 2, wherein the video object metadata includes a unique number of a camera photographing each video, a timestamp in which the video is photographed, a unique number of the tracked individual object, bounding box information, a human re-identification feature vector extracted with respect to the tracked individual object, a re-identification difficulty, and the human area image.

4. The method of claim 2, wherein the process of quantifying the re-identification difficulty includes
a process of determining whether the human object in the video is occluded by another human object within the human area image by using the bounding box information,
a process of calculating an overlapping area of a bounding box area of the other person overlapped with the human area image,
a process of calculating an occluded score by the bounding box of the human object and a ratio occupied by the overlapping area,
a process of calculating a score for a non-full body (partial) degree of the human area image by using the third deep neural network model, and
a process of calculating an average of the occluded score and the score for the non-full body degree as the re-identification difficulty.

5. The method of claim 1, wherein the process of deriving the plurality of persons which move along the GPS movement path, and the camera unit movement path of each person and the image of each person includes
a process of acquiring an identical person cluster by performing clustering for searched video object metadata for each single camera, and
a process of determining an identical cluster pair in which a plurality of different cameras are similar within the camera list by using a linear assignment algorithm.

6. The method of claim 1, wherein the monitored subject re-identification query includes the monitored subject image, video object metadata of the monitored subject, and a camera list to find the monitored subject.

7. The method of claim 2, wherein the process of matching the monitored subject and the integrated new video object metadata includes
a process of calculating a similarity between a re-identification feature vector of the new video object metadata and a re-identification feature vector of the monitored subject re-identification query,
a process of dynamically adjusting a matching threshold based on a re-identification difficulty score of the monitored subject re-identification query and a re-identification difficulty score of the new video object metadata, and
a process of determining whether the monitored subject and a human corresponding to the new video object metadata are objects having the same identity by comparing the similarity and the adjusted matching threshold.

8. The method of claim 7, wherein the similarity is calculated by using a cosine similarity or a Euclidean distance.

9. A system for CCTV-integrated monitoring, the system comprising:
at least one memory; and
at least one processor,
wherein the at least one processor executes instructions to
generate video object metadata by receiving videos photographed by a plurality of cameras,
generate a movement path re-identification query by using a camera list overlapped with a GPS movement path of a monitored subject and search time zone information integrated with the monitored subject,
search video object metadata integrated with the monitored subject based on the generated movement path re-identification query,
derive a plurality of persons which move along the GPS movement path, and a camera unit movement path of each person and an image of each person, based on the searched video object metadata,
visualize and provide the derived movement path information and person image to an interface based on a GPS,
generate a monitored subject re-identification query based on a monitored subject image selected from the interface and video object metadata corresponding to the monitored subject image,
match the monitored subject and integrated new video object metadata in new video object metadata generated in real time by the plurality of cameras based the monitored subject re-identification query, and
track a real-time location of the monitored subject based on a matching result for the monitored subject re-identification query.

10. The system of claim 9, wherein in the process of generating the video object metadata,
one or more human objects are detected from the received videos by using a pretrained first deep neural network model, and bounding box information of each object is generated,
a location of the detected human object is tracked, and an individual unique number is assigned to each object,
a human area image cropped based on the bounding box of the human object is applied to a pretrained second deep neural network model, and the human area image is converted into a multi-dimensional re-identification feature vector, and
a re-identification difficulty of the human area image is quantified by using coordinates of the bounding box and the human area image.

11. The system of claim 10, wherein the video object metadata includes a unique number of a camera photographing each video, a timestamp in which the video is photographed, a tracked individual unique number, bounding box information, a human re-identification feature vector extracted with respect to the tracked individual object, a re-identification difficulty, and the human area image.

12. The system of claim 10, wherein in the process of quantifying the re-identification difficulty,
it is determined whether the human object in the video is occluded by another human object within the human area image by using the bounding box information,
an overlapping area of a bounding box area of the other person overlapped with the human area image is calculated,
an occluded score is calculated by the bounding box of the human object and a ratio occupied by the overlapping area,
a score for a non-full body (partial) degree of the human area image is calculated by using the third deep neural network model, and
an average of the occluded score and the score for the non-full body degree is calculated as the re-identification difficulty.

13. The system of claim 9, wherein in the process of deriving the plurality of persons which move along the GPS movement path, and the camera unit movement path of each person and the image of each person,
an identical person cluster is acquired by performing clustering for searched video object metadata for each single camera, and
an identical cluster pair in which a plurality of different cameras are similar within the camera list is determined by using a linear assignment algorithm.

14. The system of claim 9, wherein the monitored subject re-identification query includes the monitored subject image, video object metadata of the monitored subject, and a camera list to find the monitored subject.

15. The system of claim 10, wherein in the process of matching the monitored subject and the integrated new video object metadata,
a similarity between a re-identification feature vector of the new video object metadata and a re-identification feature vector of the monitored subject re-identification query is calculated,
a matching threshold is dynamically adjusted based on a re-identification difficulty score of the monitored subject re-identification query and a re-identification difficulty score of the new video object metadata, and
it is determined whether the monitored subject and a human corresponding to the new video object metadata are objects having the same identity by comparing the similarity and the adjusted matching threshold.

16. The system of claim 15, wherein the similarity is calculated by using a cosine similarity or a Euclidean distance.
